(19) United States
(12) Patent Application Publication
(10) Pub. No.: US 2016/0117294 A1
(43) Pub. Date: Apr. 28, 2016

(54) METHODS, APPARATUSES, AND COMPUTER PROGRAM PRODUCTS FOR MODIFICATION OF WEBPAGE BASED ON DEVICE DATA

(71) Applicant: NOKIA TECHNOLOGIES OY, Espoo (FI)

(72) Inventors: Bing Lin, Beijing (CN); Hongrui Shen, Beijing (CN); Xiaoping Li, Beijing (CN); Bin Gao, Beijing (CN); Jing Wu, Beijing (CN)

(21) Appl. No.: 14/890,474

(22) PCT Filed: May 13, 2013
(86) PCT No.: PCT/CN2013/075539

§ 371 Date: Nov. 11, 2015

(51) Int. Cl. G06F 17/22; G06F 17/30

(52) U.S. Cl. CPC G06F 17/2247; G06F 17/30905

(57) ABSTRACT

Methods, apparatuses, and computer program products are herein provided for modification of a webpage based on device data. A method may include receiving user input directed to a device indicating a desire of a user to present a webpage on a display of the device. The method may further include determining data from the device. The method may further include causing modification of the webpage based on the data obtained from the device. Corresponding apparatuses and computer program products are also provided.

### TECHNOLOGICAL FIELD

An example embodiment of the present invention relates generally to user interface technology and, more particularly, relates to methods, apparatuses, and computer program products for modification of a webpage based on device data.

### BACKGROUND

The modern communications era has brought about a tremendous expansion of wireline and wireless networks, thereby providing more flexibility and immediacy of information transfer. Moreover, an expansion in computing power has resulted in development of affordable mobile computing devices capable of taking advantage of services made possible by modern networking technologies. Indeed, mobile computing devices can be used to perform a variety of functions, including, for example, presentation of webpages to users for browsing.

### BRIEF SUMMARY

Often, however, content of webpages may be generic and aimed at attracting a wide range of people. Indeed, a particular user may not find all of the content of the webpage relevant or interesting, forcing the user to sift through the webpage for the desired content.

As such, some example embodiments of the present invention seek to provide tailored webpages for a particular user through modification of the webpages. In some embodiments, data from the device may be used to tailor the webpage to emphasize or rearrange certain content for a particular user. Said differently, devices can store many different types of data that may provide information about a user (e.g., the songs a user listens to, the contacts of a user, etc.). Moreover, in some cases, a device may be configured to determine a current geographic location of the device. Such data may be useful in tailoring the content of a webpage for a user so as to allow for quick and easy recognition of the relevant information by the user. In such a regard, some example embodiments of the present invention provide for modification of a webpage based on device data.

In one example embodiment, a method includes receiving user input directed to a device indicating a desire of a user to present a webpage on a display of the device. The method further includes determining data from the device. The method further includes causing modification of the webpage based on the data obtained from the device.

In some embodiments, the method may include determining content of the webpage associated with the data obtained from the device. Additionally, the method may include causing modification of the webpage by causing modification of the content of the webpage associated with the data obtained from the device. In some embodiments, the method may include causing presentation of the modified webpage on the display of the device.

In some embodiments, the method may include determining data from the device by determining at least one of a geographic location of the device, a contact stored on the device, a song stored on the device, a video stored on the device, a picture stored on the device, or an application stored on the device.

In some embodiments, the method may include causing modification of the webpage by causing content of the webpage associated with the data obtained from the device to be emphasized. Additionally, in some embodiments, the method may include determining data from the device by determining the current geographic location of the device. Further, the method may include causing content of the webpage associated with the data obtained from the device to be emphasized by causing an address on the webpage closest to the geographic location of the device to be emphasized.

In some embodiments, the method may include causing modification of the webpage by causing content of the webpage associated with the data obtained from the device to be rearranged on the webpage. Additionally, in some embodiments, the method may include determining data from the device by determining the current geographic location of the device. Additionally, the method may include causing content of the webpage associated with the data obtained from the device to be rearranged on the webpage by causing an address on the webpage closest to the geographic location of the device to be rearranged on the webpage.

In some embodiments, the method may include causing presentation of the unmodified webpage. Additionally, the method may include receiving user input indicating a desire of the user to scroll through the webpage. Moreover, the method may include causing presentation of the modified webpage concurrently with causing scrolling of the webpage. Further, in some embodiments, the method may include causing presentation of the modified webpage to cease in an instance in which the scrolling of the webpage ceases.

In another example embodiment, an apparatus comprises at least one processor and at least one memory storing computer program code with the at least one memory and stored computer program code being configured, with the at least one processor, to cause the apparatus to receive user input directed to a device indicating a desire of a user to present a webpage on a display of the device. The at least one memory and stored computer program code are configured, with the at least one processor, to further cause the apparatus to determine data from the device. The at least one memory and stored computer program code are configured, with the at least one processor, to further cause the apparatus to cause modification of the webpage based on the data obtained from the device.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method including receiving user input directed to a device indicating a desire of a user to present a webpage on a display of the device. The method further includes determining data from the device. The method further includes causing modification of the webpage based on the data obtained from the device

In another example embodiment, an apparatus is provided. The apparatus comprises means for receiving user input directed to a device indicating a desire of a user to present a webpage on a display of the device. The apparatus further comprises means for determining data from the device. The apparatus further comprises means for causing modification of the webpage based on the data obtained from the device.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 illustrates a block diagram of an apparatus according to an example embodiment of the present invention;

FIG. 2 is a schematic block diagram of a mobile terminal according to an example embodiment of the present invention;

FIG. 3 illustrates an example device, such as the apparatus shown in FIG. 1, wherein a webpage is being presented on a display of the device, in accordance with an example embodiment of the present invention described herein;

FIG. 4 illustrates the apparatus shown in FIG. 3, wherein a modification to the webpage has occurred, in accordance with an example embodiment of the present invention described herein;

FIG. 5 illustrates the apparatus shown in FIG. 3, wherein another example webpage is being presented with a modification, in accordance with an example embodiment of the present invention described herein;

FIG. 6 illustrates the apparatus shown in FIG. 3, wherein yet another example webpage is being presented with a modification, in accordance with an example embodiment of the present invention described herein;

FIG. 7 illustrates the apparatus shown in FIG. 3, wherein an application is being presented with a modification, in accordance with an example embodiment of the present invention described herein;

FIG. 8 illustrates a flowchart according to an example method for modification of a webpage based on device data, in accordance with an example embodiment of the present invention described herein;

FIG. 9 illustrates a flowchart according to another example method for modification of a webpage based on device data, in accordance with an example embodiment of the present invention described herein; and

FIG. 10 illustrates a flowchart according to another example method for modification of a webpage based on device data, in accordance with an example embodiment of the present invention described herein.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

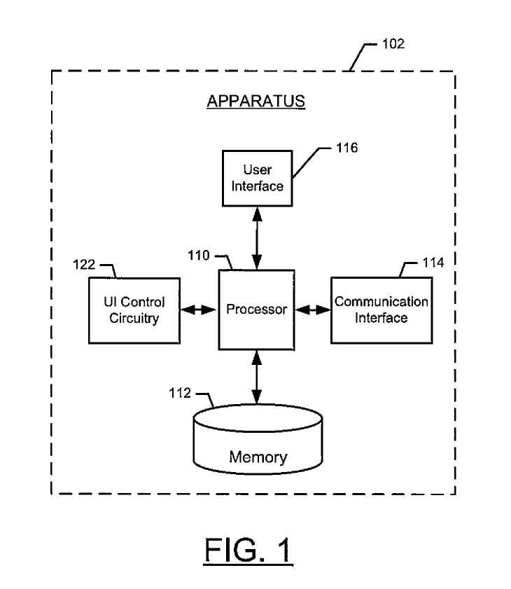

FIG. 1 illustrates a block diagram of an apparatus 102 configured for modification of a webpage based on device data according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for performing operations and operational routing, other configurations may also be used to implement embodiments of the present invention.

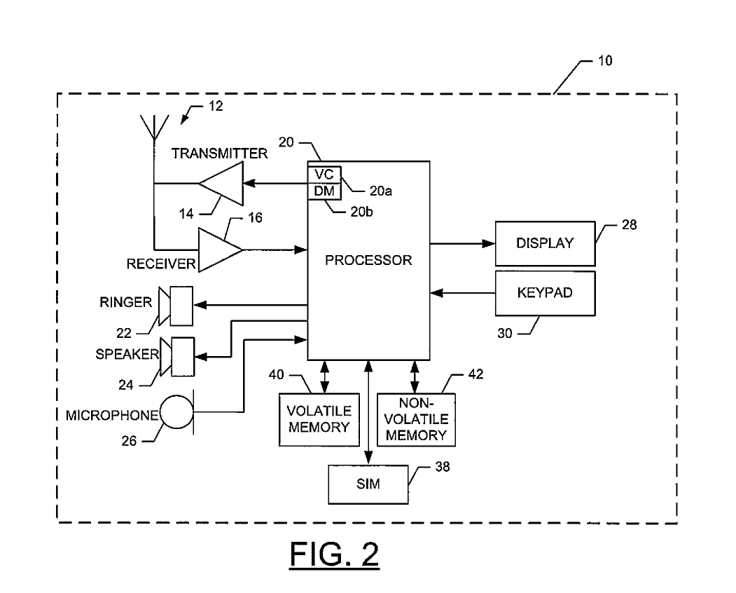

The apparatus 102 may be embodied as either a fixed device or a mobile device such as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a user interface (e.g., a touch display capable of displaying a graphical user interface). In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, positioning devices, tablet computers, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of communicating according to Wi-Fi, Near Field Communications (NFC), BlueTooth, Worldwide Interoperability for Microwave Access (WiMAX) or other proximity-based communications protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile terminal 10. Alternatively or additionally, the keypad 30 may include a conventional QWERTY keypad arrangement.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. Additionally or alternatively, the communication interface 114 may be configured to support communications in accordance with any proximity-based protocol including, for example, Wi-Fi, NFC, BlueTooth, WiMAX or the like. The communication interface 114 may additionally be in communication with the memory 112, user interface 116, and/or UI control circuitry 122, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touchscreen display, a microphone, a speaker, and/or other input/output mechanisms. In some embodiments, a display may refer to display on a screen, on a wall, on glasses (e.g., near-eye-display), in the air, etc. In embodiments wherein the apparatus 102 is embodied as a mobile terminal 10, the user interface 116 may be embodied as or comprise the display 28 and keypad 30 (shown in FIG. 2). The user interface 116 may be in communication with the memory 112, communication interface 114, and/or UI control circuitry 122, such as via a bus.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, or user interface 116, such as via a bus.

The UI control circuitry 122 may be configured to receive user input from a user interface 116, such as a touch display (e.g., touchscreen). The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine a position of the user input such as for determining a portion of the display to which the user input correlates.

The touch display may also be configured to enable the detection of a hovering gesture input. A hovering gesture input may comprise a gesture input to the touch display without making physical contact with a surface of the touch display, such as a gesture made in a space some distance above/in front of the surface of the touch display. As an example, the touch display may comprise a capacitive touch display, which may be configured to enable detection of capacitance of a finger or other input object by which a gesture may be made without physically contacting a display surface. As another example, the touch display may be configured to enable detection of a hovering gesture input through use of acoustic wave touch sensor technology, electromagnetic touch sensing technology, near field imaging technology, optical sensing technology, infrared proximity sensing technology, some combination thereof, or the like.

As noted above, the apparatus 102 (shown in FIG. 1) may be configured to perform a variety of operations. For example, in some embodiments, the apparatus 102 may be configured to communicate with a network, such as to load a webpage, send an email, or perform other functions. Other example operations may include playing a song or a video. Likewise, the apparatus 102 may be configured to take pictures, such as with a camera. Moreover, in some embodiments, the apparatus 102 may be configured to operate as a telephone. Further, in some embodiments, the apparatus 102 may be configured to determine its current geographic location (e.g., via a Global Positioning System (GPS), a Cell ID, an Internet Protocol (IP) address, etc.). In such a regard, the apparatus 102 may be configured to perform any type of operation.

Moreover, in some embodiments, the apparatus 102, such as through the memory 112, may be configured to store data associated with one or more operations. For example, the apparatus 102 may be configured to store its current geographic location. Similarly, the apparatus 102 may be configured to store a contact, a song, a video, a picture, or an application. In some embodiments, such data stored on the device may be referred to herein as “device data” or “data from the device.” In some embodiments, the device data may be specific to the particular device such that it may provide unique information about the device or the user of the device.

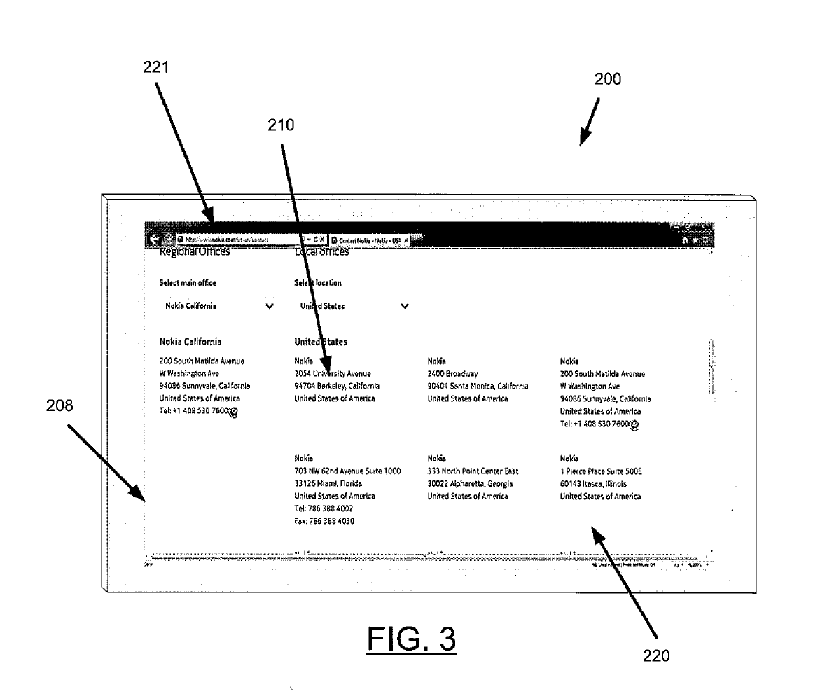

In some embodiments, the apparatus 102, such as through the user interface 116 and/or UI control circuitry 122, may be configured to receive user input directed to a device indicating a desire of a user to present a webpage on a display of the device. For example, a user may be browsing the internet and may perform user input (e.g., a “touch” gesture or input to a keyboard) indicating a desire to view a webpage. In response, in some embodiments, the apparatus 102, such as through the user interface 116 and/or UI control circuitry 122, may be configured to cause presentation of the webpage (e.g., an unmodified webpage). FIG. 3 illustrates an example device 200 (such as may embody apparatus 102). The device 200 may include a screen 208. In the depicted embodiment, a webpage 220 is being presented on the screen 208 of the device 200, such as may be associated with a web address 221. In the depicted embodiment, the portion of the webpage 220 being presented includes contact information in the form of possible contact addresses for Nokia® sites. For example, at 210, the address for “Berkeley, Calif.” is presented.

In some cases, content of webpages may be generic (e.g., aimed at attracting a wide range of people). Indeed, some content on webpages may be less important to a particular viewer. For example, with reference to FIG. 3, the webpage 220 includes many different contact addresses for Nokia® sites. However, depending on the location of the user, certain addresses may be less important or less useful. For example, if the user is located in San Diego, the Berkeley address 210 may not be desirable.

As such, some example embodiments of the present invention provide for modification of a webpage based on device data. Indeed, some embodiments of the present invention enable emphasizing and/or rearranging of content of a webpage such that the webpage is tailored for the particular user. In some embodiments, data from the device may be used to determine which content of the webpage to modify for emphasis to the user. In such a regard, a tailored webpage is presented to the user that is based on data specific to each device. This allows for quick and easy recognition of the relevant information by the user. The same concept may also be used in other operations of the device, such as during execution of an application by the device.

In some embodiments, the apparatus 102, such as through the processor 110, may be configured to determine data from the device (e.g., the memory 112, etc.). Such data may be associated with or, in some cases, stored on the device. For example, in some embodiments, the apparatus 102 may be configured to determine a geographic location of the device (e.g., the current geographic location of the device). Other possible data that the apparatus 102 may be configured to determine includes a contact stored on the device, a song stored on the device, a video stored on the device, a picture stored on the device, an application stored on the device, etc. Though the above description details some examples of data from a device to be determined, any type of data from the device may be determined. For example, in some cases, prior conversations or previously-used search terms may be stored on the device and may be determined as data from the device.

For example, the device 200 shown in FIG. 3 may determine the current geographic location of the device to be San Diego, Calif. In such a situation, the device 200 may determine that the webpage presents possible contact addresses for Nokia® sites (e.g., the “Berkeley, Calif.” contact address 210). Thus, the device 200 may determine that the content of the webpage to be modified includes the possible contact addresses.

In some embodiments, the apparatus 102, such as through the processor 110, may be configured to cause modification of the webpage based on the data obtained from the device. Such a modification may be to any aspect of the presentation of the webpage (e.g., layout, data, etc.). Further, the modification may be any type of change to the aspect of the presentation of the webpage. In some embodiments, the modification may occur at the browser level and not at the server level.

In some embodiments, the apparatus 102, such as through the processor 110, may be configured to determine content of the webpage associated with data obtained from the device. Further, in some embodiments, the apparatus 102, such as through the processor 110, may be configured to cause modification of the content of the webpage associated with data obtained from the device.

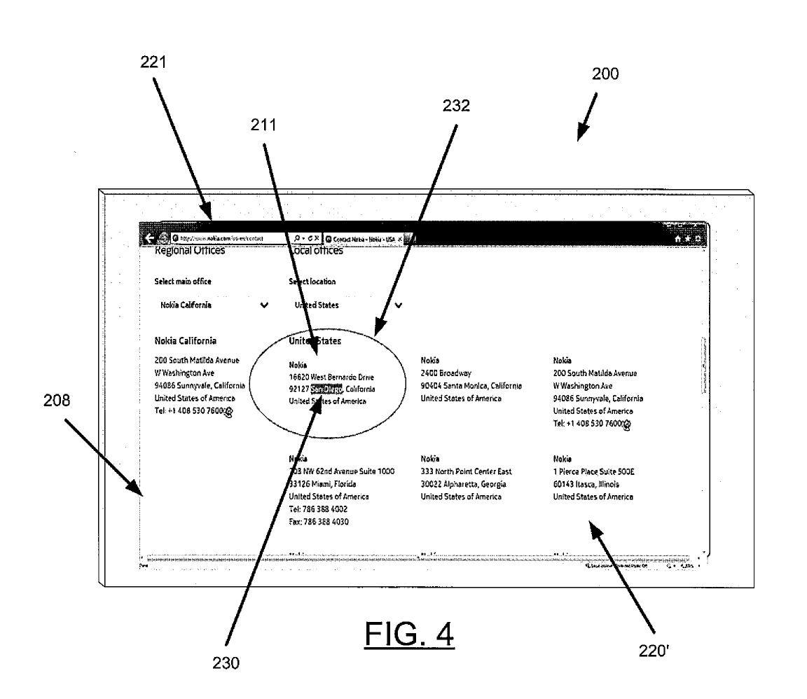

In some embodiments, the apparatus 102, such as through the user interface 116 and/or UI control circuitry 122, may be configured to cause presentation of the modified webpage on the display of the device. For example, with reference to FIG. 4, the device 200 may have modified the contact addresses of the webpage. As such, a modified webpage 220′ is presented on the screen 208.

In some embodiments, the apparatus 102, such as through the processor 110, may be configured to cause content of the webpage associated with the data obtained from the device to be emphasized (e.g., highlighted, underlined, encircled, italicized, bolded, etc.). Along these lines, in some embodiments, the apparatus 102, such as through the processor 110, may determine the current geographic location of the device and cause the content associated with that geographic location (e.g., the contact address closest to the geographic location) to be emphasized. For example, with reference to FIG. 4, the city “San Diego” is highlighted 230. Further, a circle 232 is drawn around the San Diego contact address 211. Though the above described embodiment shown in FIG. 4 details highlighting and encircling the San Diego contact address 211, some embodiments contemplate other types of emphasizing (e.g., underlining, changing font, bolding, italicizing, etc.).

Additionally or alternatively, in some embodiments, the apparatus 102, such as through the processor 110, may be configured to cause content of the webpage associated with the data obtained from the device to be rearranged on the webpage. Along these lines, in some embodiments, the apparatus 102, such as through the processor 110, may determine the current geographic location of the device and cause content associated with the geographic location (e.g., the contact address closest to the geographic location) to be rearranged on the webpage. For example, with reference to FIG. 4, the webpage 220′ has been rearranged such that the “Berkeley, Calif.” contact address 210 (shown in FIG. 3) has been replaced with a “San Diego, Calif.” contact address 211. Though the above described embodiment shown in FIG. 4 details rearranging of a contact address on the webpage to a position as the top contact address, some embodiments contemplate other types of rearranging (e.g., rearranging the entire layout of the webpage). For example, the webpage shown in FIG. 4, may be rearranged such that the San Diego contact address is presented in the margin, or anywhere on the webpage.

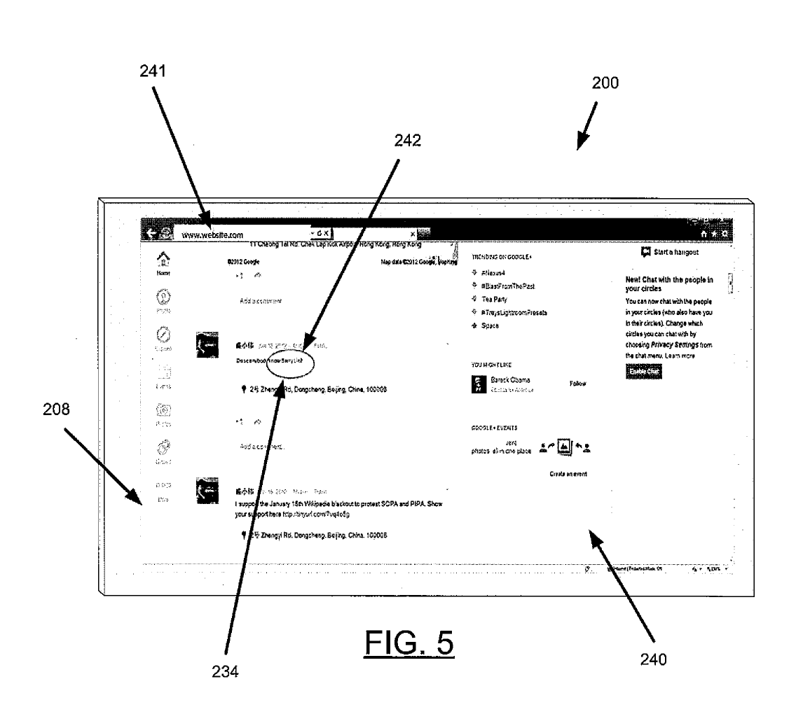

As noted above, in some embodiments, the apparatus 102, such as through the processor 110, may be configured to determine any type of data from the device. Indeed, such data, in some embodiments, may be related to personal information of the user (e.g., contacts, keywords of previous conversations, favorite websites, applications, etc.). For example, with reference to FIG. 5, the device 200 presents a modified version of a webpage 240. In particular, the device 200 has caused a modification (e.g., circle 234) directed to the name “Barry Lin” 242 presented in a scrolling feed of information on the webpage. In such a situation, Barry Lin may be a contact stored in the device 200. As such, the content of the webpage (e.g., the name Barry Lin 242) has been emphasized by having a circle 234 drawn around it.

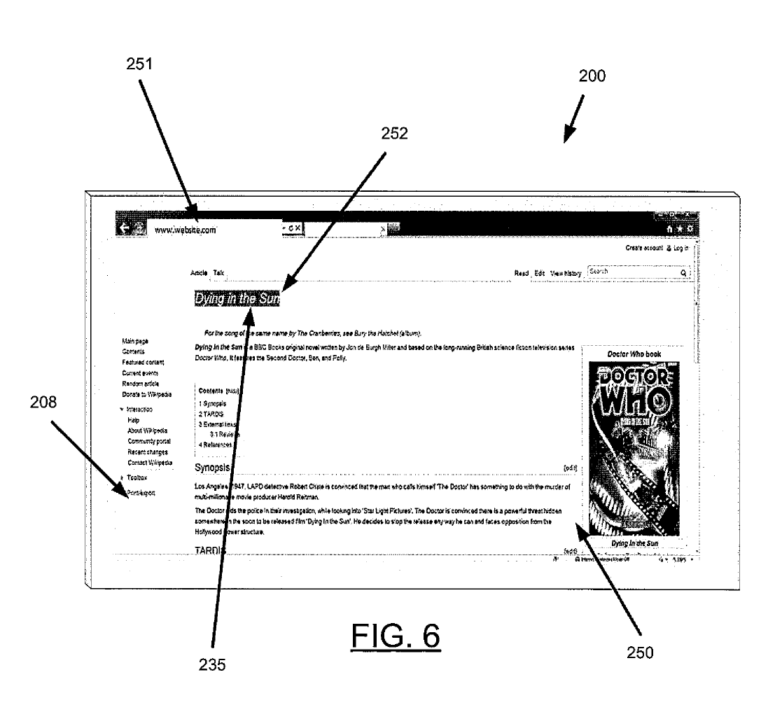

Another example modification is illustrated in FIG. 6. In that depicted embodiment, the device 200 presents a modified version of a webpage 250. In particular, the device 200 has caused a modification (e.g., highlight 235) directed to the title of the song “Dying in the Sun” 252. In such a situation, the song “Dying in the Sun” 252 may be a song stored in the device 200 (or a song recently listened to on the device 200). As such, the content of the webpage (e.g., the song “Dying in the Sun” 252) has been emphasized by being highlighted 235.

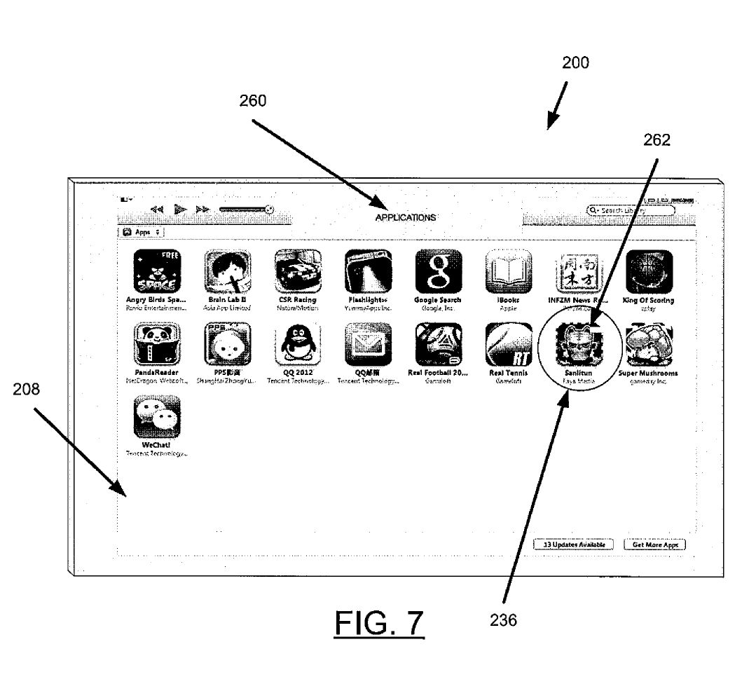

As noted above, in some embodiments, the apparatus 102, such as through the processor 110, may be configured to cause a modification to other operations besides a webpage, such as an application. In such a regard, in some embodiments, the apparatus 102 may be configured to cause modification to the application based on data obtained from the device. For example, in some embodiments, the apparatus 102 may be configured to determine content of the application that may be associated with data obtained from the device and cause modification to that content. For example, with reference to FIG. 7, the device 200 may launch an application 260. The device 200 may determine that a game 262 available for purchase through the application 260 is already installed on the device 200. In such a circumstance, the device 200 may emphasize the game 262, such as by presenting a circle 236 around the game 262.

In some embodiments, the modification of the webpage may occur or be presented while the webpage is being scrolled through. In such a regard, in some embodiments, the apparatus 102, such as through the processor 110, may be configured to cause modification of the webpage and cause presentation of the modified webpage only while the user is scrolling through the webpage. Such an embodiment provides for quick recognition of relevant information while the information is being scrolled through (e.g., moving across the screen). For example, with reference to FIG. 5, the circle 234 around the name Barry Lin 242 may occur only while the user is scrolling through the webpage 240.

Along these lines, in some embodiments, the apparatus 102, such as through the user interface 116 and/or UI control circuitry 122, may be configured to cause presentation of an unmodified webpage. The apparatus 102, however, such as through the user interface 116 and/or UI control circuitry 122, may be configured to receive user input indicating a desire of the user to scroll through the webpage. Then, in response to receiving the user input, the apparatus 102 may be configured to cause presentation of the modified webpage concurrently with causing scrolling of the webpage. Further, in some embodiments, the apparatus 102 may be configured to cause presentation of the modified webpage to cease in an instance in which the scrolling of the webpage ceases.

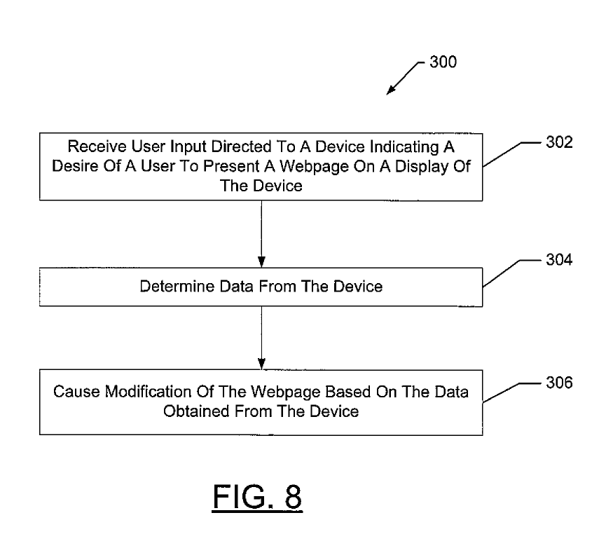

Embodiments of the present invention provide methods, apparatus and computer program products for modification of a webpage based on device data. Various examples of the operations performed in accordance with embodiments of the present invention will now be provided with reference to FIGS. 8-10.

FIG. 8 illustrates a flowchart according to an example method for modification of a webpage based on device data according to an example embodiment 300. The operations illustrated in and described with respect to FIG. 8 may, for example, be performed by, with the assistance of, and/or under the control of one or more of the processor 110, memory 112, communication interface 114, user interface 116, or UI control circuitry 122 (shown in FIG. 1). Operation 302 may comprise receiving user input directed to a device indicating a desire of a user to present a webpage on a display of the device. The processor 110, user interface 116, and/or UI control circuitry 122 may, for example, provide means for performing operation 302. Operation 304 may comprise determining data from the device. The processor 110 may, for example, provide means for performing operation 304. Operation 306 may comprise causing modification of the webpage based on the data obtained from the device. The processor 110, user interface 116, and/or UI control circuitry 122 may, for example, provide means for performing operation 306.

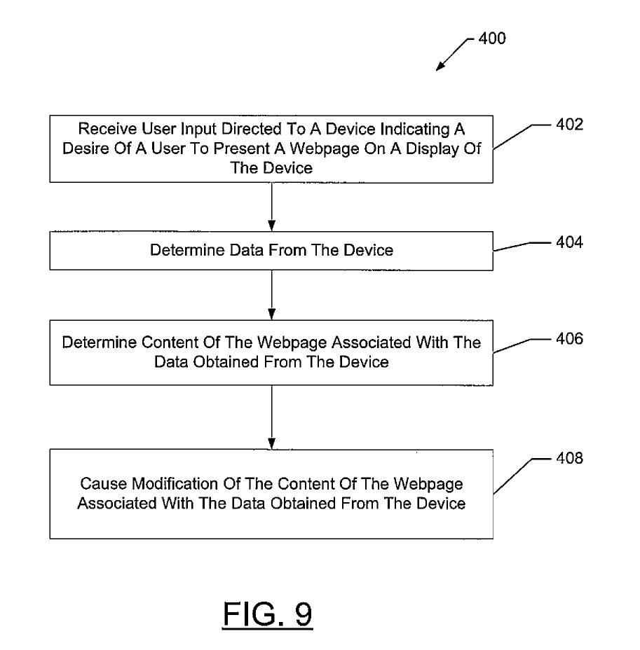

FIG. 9 illustrates a flowchart according to another example method for modification of a webpage based on device data according to an example embodiment 400. The operations illustrated in and described with respect to FIG. 9 may, for example, be performed by, with the assistance of, and/or under the control of one or more of the processor 110, memory 112, communication interface 114, user interface 116, or UI control circuitry 122 (shown in FIG. 1). Operation 402 may comprise receiving user input directed to a device indicating a desire of a user to present a webpage on a display of the device. The processor 110, user interface 116, and/or UI control circuitry 122 may, for example, provide means for performing operation 402. Operation 404 may comprise determining data from the device. The processor 110 may, for example, provide means for performing operation 404. Operation 406 may comprise determining content of the webpage associated with the data obtained from the device. The processor 110 may, for example, provide means for performing operation 406. Operation 408 may comprise causing modification of the content of the webpage associated with the data obtained from the device. The processor 110, user interface 116, and/or UI control circuitry 122 may, for example, provide means for performing operation 408.

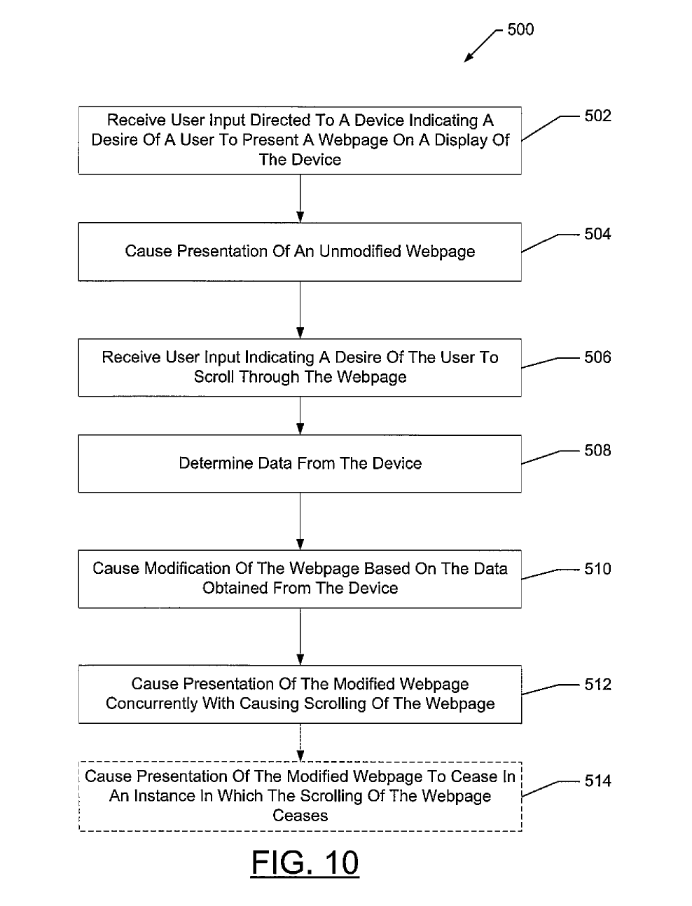

FIG. 10 illustrates a flowchart according to yet another example method for modification of a webpage based on device data according to an example embodiment 500. The operations illustrated in and described with respect to FIG. 10 may, for example, be performed by, with the assistance of, and/or under the control of one or more of the processor 110, memory 112, communication interface 114, user interface 116, or UI control circuitry 122 (shown in FIG. 1). Operation 502 may comprise receiving user input directed to a device indicating a desire of a user to present a webpage on a display of the device. The processor 110, user interface 116, and/or UI control circuitry 122 may, for example, provide means for performing operation 502. Operation 504 may comprise causing presentation of an unmodified webpage on the display of the device. The processor 110, user interface 116, and/or UI control circuitry 122 may, for example, provide means for performing operation 504. Operation 506 may comprise receiving user input indicating a desire of the user to scroll through the webpage. The processor 110, user interface 116, and/or UI control circuitry 122 may, for example, provide means for performing operation 506. Operation 508 may comprise determining data from the device. The processor 110 may, for example, provide means for performing operation 508. Operation 510 may comprise causing modification of the webpage based on the data obtained from the device. The processor 110, user interface 116, and/or UI control circuitry 122 may, for example, provide means for performing operation 510. Operation 512 may comprise causing presentation of the modified webpage on the display of the device concurrently with causing scrolling of the webpage. The processor 110, user interface 116, and/or UI control circuitry 122 may, for example, provide means for performing operation 512. Additionally, in some embodiments, operation 514 may comprise causing presentation of the modified webpage to cease in an instance in which the scrolling of the webpage ceases. The processor 110, user interface 116, and/or UI control circuitry 122 may, for example, provide means for performing operation 514.

FIGS. 8-10 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1-21. (canceled)

22. A method comprising:
receiving user input directed to a device indicating a desire of a user to present a webpage on a display of the device;
determining, by a processor, data from the device; and
causing modification of the webpage based on the data obtained from the device.

23. The method according to claim 22 further comprising determining content of the webpage associated with the data obtained from the device, wherein causing modification of the webpage comprises causing modification of the content of the webpage associated with the data obtained from the device.

24. The method according to claim 22, wherein determining data from the device comprises determining at least one of a geographic location of the device, a contact stored on the device, a song stored on the device, a video stored on the device, a picture stored on the device, or an application stored on the device.

25. The method according to claim 22, wherein causing modification of the webpage comprises causing content of the webpage associated with the data obtained from the device to be emphasized.

26. The method according to claim 25, wherein determining data from the device comprises determining a current geographic location of the device, and wherein causing content of the webpage associated with the data obtained from the device to be emphasized comprises causing an address on the webpage closest to the geographic location of the device to be emphasized.

27. The method according to claim 22, wherein causing modification of the webpage comprises causing content of the webpage associated with the data obtained from the device to be rearranged on the webpage.

28. The method according to claim 27, wherein determining data from the device comprises determining the current geographic location of the device, and wherein causing content of the webpage associated with the data obtained from the device to be rearranged on the webpage comprises causing an address on the webpage closest to the geographic location of the device to be rearranged on the webpage.

29. The method according to claim 22 further comprising causing presentation of the modified webpage on the display of the device.

30. The method according to claim 22 further comprising:
causing presentation of the unmodified webpage;
receiving user input indicating a desire of the user to scroll through the webpage; and
causing presentation of the modified webpage concurrently with causing scrolling of the webpage.

31. The method according to claim 30, further comprising causing presentation of the modified webpage to cease in an instance in which the scrolling of the webpage ceases.

32. An apparatus comprising a processor and a memory including computer program code, the memory and the computer program code configured to, with the processor, cause the apparatus to:
receive user input directed to a device indicating a desire of a user to present a webpage on a display of the device;
determine data from the device; and
cause modification of the webpage based on the data obtained from the device.

33. The apparatus according to claim 32, wherein the memory and the computer program code are further configured to, with the processor, cause the apparatus to:
determine content of the webpage associated with the data obtained from the device; and
cause modification of the webpage by causing modification of the content of the webpage associated with the data obtained from the device.

34. The apparatus according to claim 32, wherein the memory and the computer program code are further configured to, with the processor, cause the apparatus to determine data from the device by determining at least one of a geographic location of the device, a contact stored on the device, a song stored on the device, a video stored on the device, a picture stored on the device, or an application stored on the device.

35. The apparatus according to claim 32, wherein the memory and the computer program code are further configured to, with the processor, cause the apparatus to cause modification of the webpage by causing content of the webpage associated with the data obtained from the device to be emphasized.

36. The apparatus according to claim 35, wherein the memory and the computer program code are further configured to, with the processor, cause the apparatus to:
determine data from the device by determining the current geographic location of the device; and
cause content of the webpage associated with the data obtained from the device to be emphasized by causing an address on the webpage closest to the geographic location of the device to be emphasized.

37. The apparatus according to claim 32, wherein the memory and the computer program code are further configured to, with the processor, cause the apparatus to cause modification of the webpage by causing content of the webpage associated with the data obtained from the device to be rearranged on the webpage.

38. The apparatus of claim 37, wherein the memory and the computer program code are further configured to, with the processor, cause the apparatus to:
determine data from the device by determining a current geographic location of the device; and
cause content of the webpage associated with the data obtained from the device to be rearranged on the webpage by causing an address on the webpage closest to the geographic location of the device to be rearranged on the webpage.

39. Computer program product comprising a non-transitory computer readable medium having program code portions stored thereon, the program code portions being a computer readable medium and configured when said program product is run on a computer or network device, to:
receive user input directed to a device indicating a desire of a user to present a webpage on a display of the device;
determine data from the device; and
cause modification of the webpage based on the data obtained from the device.

40. The computer program product according to claim 39, wherein the program code portions are further configured, when said program product is run on a computer or network device, to:
determine content of the webpage associated with the data obtained from the device; and
cause modification of the webpage by causing modification of the content of the webpage associated with the data obtained from the device.

41. The computer program product according to claim 39, wherein the program code portions are further configured, when said program product is run on a computer or network device, to determine data from the device by determining at least one of a geographic location of the device, a contact stored on the device, a song stored on the device, a video stored on the device, a picture stored on the device, or an application stored on the device.
